(19) United States
(12) Patent Application Publication
(10) Pub. No.: US 2014/0335307 A1
(43) Pub. Date: Nov. 13, 2014

(54) INTERIOR COMPONENT FOR A VEHICLE

(71) Applicants: Ullrich Münstermann, Egelsbach (DE); Johann Gasslhuber, Buch am Erlbach (DE); Peter Strasser, Altford (DE)

(72) Inventors: Ullrich Münstermann, Egelsbach (DE); Johann Gasslhuber, Buch am Erlbach (DE); Peter Strasser, Altford (DE)

(21) Appl. No.: 14/365,393

(22) PCT Filed: Dec. 21, 2012
(86) PCT No.: PCT/EP2012/076594

§ 371 Date: Jun. 13, 2014

(30) Foreign Application Priority Data
Dec. 22, 2011 (DE) 102011056933.2

(51) Int. Cl. D06N 3/00; B60R 13/00; D06B 1/04; B32B 5/02; D04H 3/11

(52) U.S. Cl. CPC D06N 3/0011; B32B 5/022; D04H 3/11; D06N 3/0088; D06B 1/04; B60R 13/00; D10B 2201/01
USPC 428/138; 442/153; 442/394; 428/165; 442/79; 442/93; 442/134; 442/131; 442/408; 264/103

(57) ABSTRACT

The present invention relates to a interior component (10) for a motor vehicle, which interior component has a top layer (1) composed of liquid-jet-hardened natural fibre nonwoven material or a top layer (1) composed of a liquid-jet-hardened mixture of different natural fibre nonwoven materials. The invention also relates to a motor vehicle having at least one such interior component, and to the use of a liquid-jet-hardened natural fibre nonwoven material or a mixture of natural fibre nonwoven materials as a top layer (1) in an interior component (10), in particular a cockpit component, of a motor vehicle.

The present invention relates to an interior component for a motor vehicle. The invention further relates to one motor vehicle, comprising at least one interior component, as well as the use of a natural fibre nonwoven material which is hardened by fluid jet, in particular hardened by water jet, in a motor vehicle.

Interior components, such as for example cockpits or instrument panels, of motor vehicles are constructed differently. Currently such interior components are produced principally from injection moulded plastic. In the case of vehicles of lower quality the surfaces which face the interior of the motor vehicle are often left shiny or lacquered or varnished. In the higher-quality categories of motor vehicle the surfaces are generally of a higher grade. Such interior components are coated with films, in particular compact or foam films, or substrate and film are foam-backed together. In the luxury motor vehicle sector the surfaces of the interior components frequently consist of sewn coverings made of artificial leather or real leather. With the exception of real leather, most of the conventional surface materials are formed principally from petrochemical products, such as polyurethane, thermoplastic elastomers and polyolefins or polyvinyl chloride.

In particular in the lower-quality motor vehicles the interior components are rather hard and without additional decoration. Interior components and surfaces of interior components, which consist completely or principally of petrochemical products, are frequently viewed critically by customers due to the increasing environmental awareness. Interior components which are provided with sewn coverings made of plastic or real leather are certainly relatively high-grade, but expensive and with regard to surfaces are heavy.

It is an object of the present invention at least partially to eliminate the aforementioned disadvantages in interior components, in particular in cockpits, of motor vehicles. In particular the object of the present invention is to provide interior components for a motor vehicle which can be produced cost-effectively, which are of lightweight construction and have a high level of customer acceptance.

The aforementioned object is achieved by an interior component for a motor vehicle with the features of Claim 1, by a motor vehicle with the features of Claim 15, by the use of natural fibre nonwoven material with the features according to Claim 16 and by a method with the features of Claim 17. Further features and details of the invention are apparent from the subordinate claims, the description and the drawings. In this case features and details which are described in connection with the interior component according to the invention also of course apply in connection with the motor vehicle according to the invention, the use of according to the invention of natural fibre nonwoven material and to the method according to the invention and in each case vice versa, so that with respect to the disclosure reference is or can be always made reciprocally to the individual aspects of the invention.

According to a first aspect of the invention the object is achieved by an interior component for a motor vehicle, wherein the interior component has a covering layer made natural fibre nonwoven material of hardened by fluid jet or a covering layer made of a mixture of different natural fibre nonwoven materials hardened by fluid jet. In the light the invention natural fibre nonwoven materials constitute nonwoven fabrics. A nonwoven fabric is characterised in that it is a sheet material manufactured from fibres. That is to say, nonwoven fabric is produced from fibres. The fibres of the natural fibre nonwoven materials or the nonwoven fabrics can be of different lengths. For example the fibres can be very short, but can also have almost endless filaments. An interior component constructed in such a way for a motor vehicle, in particular a cockpit component, such as for example an instrument panel, can be produced cost-effectively, since natural fibre nonwoven material as a renewable raw material can be applied easily and cost-effectively. Furthermore interior components which have a covering layer of natural fibre nonwoven material or a mixture of natural fibre nonwoven materials are of lightweight construction because of the low weight of the natural fibre nonwoven material, so that by comparison with interior components made of plastic or leather a significant saving of weight is possible. A further crucial advantage is the high level of customer acceptance of natural fibre nonwoven material. Since the natural fibre nonwoven materials are renewable biological raw materials, as expected they have a high level of acceptance among motor vehicle customers. In particular interior components which have a covering layer of natural fibre nonwoven material or a mixture of different natural fibre nonwoven materials can be disposed of simply and cost-effectively, by comparison with interior components with a cover layer made of petrochemical products.

According to the invention the interior component can be formed completely from, the covering layer. In this case the covering layer has a specific strength, in particular a strength of 0.07 to 3 cm or more, in order thereby to obtain a certain stability.

The crux of the invention is that the covering layer of the interior component is formed from a natural fibre nonwoven material hardened by fluid jet or by a mixture of different natural fibre nonwoven materials hardened by fluid jet. In the so-called nonwovens sector it has been known for a relatively long time to treat non-woven materials, in particular to harden them, by fluid jet hardening. Within the meaning of the invention fluid jet hardening means that the natural fibre nonwoven materials are processed by vapour jet hardening or by liquid jet hardening. The design principle of fluid jet hardening consists of specific pumps generating fluid pressures of up to 400 bars. The compressed fluid is distributed uniformly in so-called nozzle bars over the necessary working width and is led through the nozzle strip which is provided with openings of less than 0.15 mm, so that a fluid curtain is produced. The fluid jets, that is to say the vapour or liquid jets of, impinge on the unhardened natural fibre nonwoven material at a speed of up to 350 m/s. The fluid is sucked in by the natural fibre nonwoven material and then recycled in an individually applied filtration process.

Depending upon the strength of the pressure at which the fluid impinges on the natural fibre nonwoven material, it is possible to produce interior components which are hardened to differing degrees. The higher the pressure is, the more the covering layer of the interior component is hardened. This means that the elasticity of the covering layer produced can be influenced by an adjustment of the pressure at which the fluid through the nozzles impinges on the natural fibre nonwoven material. Interior components which have been produced from a natural fibre nonwoven material hardened by fluid jet and which have been hardened at a pressure between 20 and 100 bars have a higher elasticity than natural fibre nonwoven materials which have been hardened by fluid jet at pressures of over 100 bars. Particularly preferably an interior component according to the invention has a covering layer which is hardened by fluid jet at a pressure of less than 40 bars, in particular at a pressure of 20 to 40 bars.

An interior component for a motor vehicle is particularly preferred in which the covering layer has a natural fibre nonwoven material hardened by water jet or mixture of different natural fibre nonwoven materials hardened by water jet. Interior components constructed in this way can be produced on the basis of the use of water.

The thicker the covering layer and thus the interior component are, the more dimensionally stable it is. According to a particularly preferred further development of the invention it may be provided in an interior component that the natural fibre nonwoven material of the covering layer of the interior component includes cotton, flax, jute, hemp, kenaf, sisal, abaca, coconut and/or viscose. Such natural fibres can be produced simply and cost-effectively. In particular the natural fibres are frequently waste products. Thus for example cotton fibres are used which are obtained as waste products in the exploitation of cotton. The covering layers of the interior components which are made of natural fibre nonwoven materials or a mixture of natural fibre nonwoven materials advantageously have a weight per unit area of 100 to 1000 g/m², in particular weight per unit area of 100 until 350 g/m². For example the covering layer of the interior component can be made purely of cotton, purely of flax, purely of hemp or purely of viscose. Of course covering layers made of other natural fibre nonwoven materials are also conceivable. Furthermore the covering layer of an interior component can be formed from two or more different natural fibre materials. The advantage of a mixture of different natural fibre nonwoven materials resides in the fact that natural limitations of the quality parameters of several natural fibre nonwoven materials can be compensated for by the addition of other natural fibre nonwoven materials. A reinforced mixture of different natural fibre nonwoven materials based on flax and sisal, wherein the flax constitutes the finer component and the sisal introduces a certain rigidity into the non-woven material.

Furthermore in an interior component it can advantageously be provided that the covering layer has a small proportion of synthetic fibres, in particular viscose fibres. This means that a large proportion, for example 70-90%, of the covering layer consists of natural fibre nonwoven material(s) and a smaller proportion, for 10-30%, consists of synthetic fibres, such as fibres of natural polymers or of synthetic polymers. This means that the synthetic fibres can be fibres of natural polymers or fibre of synthetic polymers. Of course mixtures of fibres of natural polymers and fibres of synthetic polymers can be used.

According to a particularly preferred further development of the invention it may be provided in an interior component that the covering layer is disposed on a support layer of the interior component. An interior component constructed in this way for a motor vehicle has the necessary rigidity because of the use of a support layer as well as a required surface softness (haptics) because of the use of the covering layer made of natural fibre nonwoven materials. In this case the support layer of the interior component is advantageously dimensionally stable, so that the covering layer made of natural fibre nonwoven material(s) can be of elastic construction.

The support layer of a previously described interior component can be formed from various kinds of materials. For example it is conceivable that the support layer is formed a light metal, such as for example aluminium. Particularly preferably the support layer of an interior component is constructed as a plastic part, in particular as an injection moulded plastic part, and/or as a natural fibre pressed material. Support layers constructed in this way can be produced cost-effectively and simply and form a dimensionally stable basis to receive a covering layer made of natural fibre nonwoven material. Thus it is conceivable for example that the support layer has both proportions made of plastic and also proportions made of natural fibres. This ensures, on the one hand, that a certain stability of the support layer is provided and, on the other hand, that the support layer is of relatively lightweight construction. Furthermore a high level of customer acceptance is achieved by the use of natural fibre pressed material in the support layer. Likewise by the use of predominantly natural fibre nonwoven material in such an interior component ensures a simple, environmentally friendly and cost-effective disposal.

A further preferred interior component according to the invention is characterised in that a haptic layer, in particular of polyurethane or thermoplastic elastomer, is disposed between the support layer and the covering layer. The use of such a haptic layer between the support layer and the covering layer ensures a good and durable elasticity of the interior component. By the use of such an additional haptic layer in an interior component a so-called soft-touch under the covering layer or an increase of the soft-touch of the covering layer are produced. The haptic layer is elastic by comparison with the support layer and effects a specific, pleasantly perceived haptics of the interior component. The haptic layer can for example be adhered to the support layer or connected thereto in another way. Likewise the covering layer can be adhered to the haptic layer or connected thereto in another way. Particularly preferably the haptic layer is made of polyurethane, in particular of polyurethane foam. Such a haptic layer is characterised by high flexibility as well as good heat- and sound-insulating characteristics and can be foamed without adhesive directly between substrate and haptic layer. Likewise haptic layers can be used in the form of spacer fabrics preferably made of polyester. For example the haptic layer can also be formed from thermoplastic elastomer, for example TPO foam. TPOs are thermoplastic olefin elastomers which have a specific proportion of elastomer to increase the softness of the haptic layer. Also waddings or nonwovens can be used as haptic layer. Such haptic layers are in particular free of softeners and are distinguished in particular by a low weight.

In the installed state of the interior component the covering layer of the interior component is facing the interior of the motor vehicle. It may be advantageous if the covering layer has a smooth surface at least on the side facing the interior of the motor vehicle in the installed state of the interior component. Furthermore an interior component is preferred in which the covering layer is structured at least on the side facing the interior of the motor vehicle in the installed state of the interior component. In this way the covering layer of the interior component has a high surface quality as well as a good appearance.

It is a further advantage if in an interior component the covering layer is at least partially perforated and/or embossed. In this way the covering layer and thus the interior component are designed to be on the one hand particularly lightweight and on the other hand functional. Both a perforated and also an embossed form of the covering layer can be produced by the fluid jet hardening of the natural fibre nonwoven material. For example the covering layer can have holes regularly spaced apart. In the production of the covering layer deformations can be produced in the surface of the covering layer by special tools, so that this layer is perforated and/or embossed. The embossing of the covering layer can take place example by calendering. In this case embossing or goffering calenders can be used in particular.

An interior component according to the invention is further characterised in that the covering layer is made dirt- and moisture-repellent, scratch-resistant, climate-proof and/or radiation-resistant by dipping in a liquid. In particular an interior component is of advantage in which the covering layer is UV radiation-resistant due to dipping by means of a specific liquid. An interior component constructed in such a way ensures that neither dirt nor moisture can penetrate into the covering layer of the interior component. Furthermore such an interior component has a long service life because it is scratch-resistant as well as climate-proof, in particular radiation-resistant.

According to a particularly preferred further development of the invention, in an interior component it may be provided that in the installed state of the interior component a protective layer is disposed on the covering layer at least on the side facing the interior of the motor vehicle. The thin protective coating ensures that the covering layer of the interior component is particularly protected against external effects. Particularly preferably the protective layer is transparent. By a thin and transparent construction of the protective coating it is ensured that the covering layer made of natural fibre nonwoven material or of a mixture of different natural fibre nonwoven materials remains visible to the user of a motor vehicle. As a result in particular the high level of customer acceptance is ensured. The thin protective coating can for example be disposed as a thin film on the covering layer or applied as a lacquer layer on the covering layer or for example by pouring polyurethane over the covering layer in a shaping tool. An interior component is particularly preferred in which the protective coating is dirt- and moisture-repellent, scratch-resistant, climate-proof and/or radiation-resistant. An interior component constructed in such a way for a motor vehicle is lightweight, has a high load capacity and is durable over the service life of the motor vehicle. Because at least the covering layer is made of natural fibre nonwoven material, such an interior component is lighter, more environmentally friendly and can be disposed of more cost-effectively than known interior components which are predominantly made of petrochemical products.

Various components in the interior of the motor vehicle may be considered as interior components. Particularly preferably the interior component is a cockpit component of the motor vehicle, in particular the instrument panel a motor vehicle.

According to a second aspect of the invention the object is achieved by a motor vehicle having at least one interior component, wherein the interior component i constructed according to the first feature of the invention. Thus all the advantages which have been described in relation to an interior component according to the first aspect of the invention are also applicable to a motor vehicle according to the invention. Motor vehicles are in particular passenger cars or trucks. However, it is also conceivable that the motor vehicle is a boat or a ship as well as an aircraft.

According to a third aspect of the invention the object is achieved by the use of a natural fibre nonwoven material hardened by fluid jet, in particular hardened by water jet, or a mixture of natural fibre nonwoven materials hardened by fluid jet, in particular hardened by water jet, as covering layer in an interior component, in particular a cockpit component, of a motor vehicle. Also when a natural fibre nonwoven material hardened by fluid jet of a mixture of different natural fibre nonwoven materials hardened by fluid jet is used this results in all the advantages which have been described in relation to an interior component according to the first aspect of the invention.

According to a fourth aspect of the invention the object is achieved by a method for producing a covering layer of an interior component for a motor vehicle, wherein the method is characterised by the following method steps:

a) A natural fibre nonwoven material which has a weight per unit area of 100 to 1000 g/m² or a mixture of different natural fibre nonwoven materials which has a weight per unit area of 100 to 1000 g/m² is hardened by fluid jet hardening at a pressure of over 100 bars, and

b) then in a calender embossing of at least a part of the surface of the hardened natural fibre nonwoven material or of the hardened mixture of different natural fibre nonwoven materials is produced.

Depending upon the strength of the pressure at which the fluid impinges on the natural fibre nonwoven material, it is possible to produce interior components which are hardened to differing degrees. The higher the pressure is, the more the covering layer of the interior component is hardened. This means that the elasticity of the covering layer produced can be influenced by an adjustment of the pressure at which the fluid through the nozzles impinges on the natural fibre nonwoven material. Interior components which have been produced from a natural fibre nonwoven material hardened by fluid jet and which have been hardened at a pressure between 20 and 100 bars have a higher elasticity than natural fibre nonwoven materials which have been hardened by fluid jet at pressures of over 100 bars.

Preferably in a method it may be provided that the weight per unit area of the natural fibre nonwoven material or of the mixture of different natural fibre nonwoven materials is 100 to 1000 g/m².

Furthermore in a method it may be provided that a protective layer is applied to the surface of the covering layer. Particularly preferably the protective layer is transparent. The protective coating can be applied by arrangement of a thin film, by application of a lacquer layer or by pouring polyurethane over the covering layer in a shaping tool. Likewise in a method it may be provided that the protective layer is dirt- and moisture-repellent, scratch-resistant, climate-proof and/or radiation-resistant.

Furthermore in a method it may be provided that the fluid jets are applied to the unhardened natural fibre nonwoven material or the unhardened mixture of different natural fibre nonwoven materials at a speed of up to 350 m/s. The fluid is sucked in by the natural fibre nonwoven material and then recycled in an individually applied filtration process.

Furthermore in a method it may be provided that the hardening of the natural fibre nonwoven material or of the mixture of different natural fibre nonwoven materials is carried out by vapour jets or by liquid jets.

Preferably in a method it may be provided that the covering layer is disposed on a support layer of the interior component.

Also a haptic layer, in particular of polyurethane or thermoplastic elastomer, can be disposed between the support layer and the covering layer. By the use of such an additional haptic layer in an interior component a so-called soft-touch under the covering layer or an increase of the soft-touch of the covering layer are produced. The haptic layer can for example be adhered to the support layer or connected thereto in another way. Likewise the covering layer can be adhered to the haptic layer or connected thereto in another way. Particularly preferably the haptic layer can be made of polyurethane, in particular of polyurethane foam. Such a haptic layer is characterised by high flexibility as well as good heat- and sound-insulating characteristics and can be foamed without adhesive directly between substrate and haptic layer.

In particular an interior component for a motor vehicle according to the first aspect of the invention can be produced by a previously described method.

An interior component according to the invention and modifications thereof as well as the advantages thereof are explained in greater detail below with reference to drawings. In the schematic drawings:

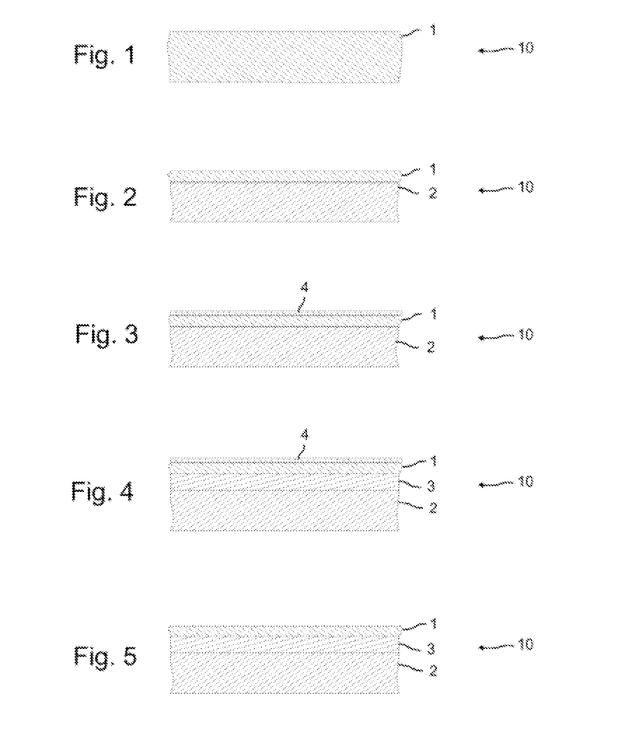

FIG. 1 shows a section through an interior component which is constructed following the design principle according to the invention,

FIG. 2 shows a section through another interior component, having a covering layer, which is constructed following the design principle according to the invention,

FIG. 3 shows a section through a further interior component, having a covering layer as well as a protective layer, which is constructed following the design principle according to the invention,

FIG. 4 shows a section through a further interior component, having a haptic layer, a covering layer as well as a protective layer, which is constructed following the design principle according to the invention,

FIG. 5 shows a section through a further interior component, having a haptic layer and a covering layer.

Elements with the same function and mode of operation are provided in FIGS. 1 to 5 in each case with the same reference numerals.

A portion of an interior component 10 is shown schematically in FIG. 1 for a motor vehicle which is constructed following the design principle according to the invention. The interior component 10 has a covering layer 1 made of a natural fibre nonwoven material hardened by fluid jet, in particular hardened by water jet. In this embodiment of the interior component 10 the covering layer 1 completely forms the interior component 10. By comparison with the interior components 10 shown in FIGS. 2 to 4, in the interior component 10 according to FIG. 1 the covering layer 1 is of significantly thicker construction. In this way the interior component 10 acquires a dimensional stability, so that it can be used in a motor vehicle. An interior component 10 constructed in such a way can be produced simply and cost-effectively. This is achieved in particular by the use of natural fibre nonwoven materials. In particular, waste products can also be used as fibre material. Cotton, flax, jute, hemp, kenaf, coconut, abaca, sisal and/or viscose can be used as natural fibre nonwoven material. Because the covering layer 1 has natural fibre nonwoven material hardened by fluid jet, an elasticity and a pleasant haptics of the interior component 10 are provided.

In FIG. 2 a section of a further interior component 10 is shown schematically for a motor vehicle. The interior component 10 is characterised in that it has a covering layer 1 as well as a support layer 2. In this case the covering layer 1 is fastened, in particular adhered, to the support layer 2. The support layer 2 which is constructed in particular as a plastic part and/or natural fibre pressed material ensures a high stability of the interior component, wherein the covering layer 1 serves for good elasticity and thus for a pleasant haptics of the interior component 10. By comparison with the interior component 10 according to FIG. 1, the covering layer 1 in the interior component 10 according to FIG. 2 is of significantly thinner construction, since this does not have to serve for sufficient stability of the interior component 10.

FIG. 3 shows schematically a section through another interior component which is constructed following the design principle according to the invention. In this interior component 10 a protective layer 4 is additionally disposed on the side of the covering layer 1 facing away from the support layer 2. This protective layer 4 serves for even better protection of the interior component 10, in particular for improved protection of the covering layer 1 of the interior component 10. In particular the protective coating 4 is dirt- and moisture-repellent. As a result it is ensured that neither dirt nor liquid can penetrate into the interior component 10. Furthermore such a protective layer 4 is characterised in that it is scratch-resistant, climate-proof and/or radiation-resistant. As a result a long service life of the interior component 10, in particular a service life of the interior component 10 over the service life of a motor vehicle, is ensured. The protective layer 4 can be constructed as a film, for example as a polyurethane film. As an alternative to this the protective layer 4 can be lacquered on or poured on. In particular the protective coating 4 is thin and transparent, so that the covering layer 1 disposed below the protective layer 4 remains visible by a user of a motor vehicle. By the use and the visibility of the covering layer 1 made of natural fibre nonwoven material a high level of customer acceptance is ensured, since natural fibre nonwoven materials are renewable, ecological raw materials.

In FIG. 4 a section of a further interior component 10 for a motor vehicle is shown schematically. This interior component 10 is characterised in that by comparison with the interior component according to FIG. 3 a haptic layer is additionally disposed between the covering layer 1 and the support layer 2. This haptic layer 3 serves for increase of the soft-touch feel of the interior component 10. In particular the haptic layer 3 serves for a high elasticity of the surface of the interior component 10. In the event of contact of the interior component 10 a vehicle occupant perceives a pleasant smooth haptics of the interior component 10. This is achieved in particular by the use of the additional haptic layer 3. The haptic layer 3 is advantageously made of polyurethane, in particular of polyurethane foam, or of thermoplastic elastomer, for example a-TPO foam or a spacer fabric.

FIG. 5 shows a section through a further interior component 10, having a haptic layer 3 and a covering layer 1. In this interior component 10 there is no protective layer 4, such as the interior components 10 according to FIGS. 3 and 4. So that the cover layer 1 is dirt- and moisture-repellent, scratch-resistant, climate-proof and/or radiation-resistant, it can advantageously be dipped in a special liquid.

It is common to all the interior components 10 according to FIGS. 1 to 5 that these can be produced simply and cost-effectively by the use of natural fibre nonwoven materials hardened by fluid jet or by the use of a mixture of natural fibre nonwoven materials, they are of lightweight construction and are characterised by a high level of customer acceptance. Depending upon the pressure with which the natural fibre nonwoven materials are hardened by fluid jet, a different level of softness of the covering layer 1 can be ensured. An increase in the softness of the interior component 10 is achieved by the additional use of the haptic layer 3, according to FIGS. 4 and 5. Due to the high proportion of natural fibre nonwoven material such interior components 10 can be disposed of and even recycled simply, cost-effectively and environmentally friendly.

The preceding embodiments of the interior components describe the present invention only in the context of examples. Of course individual features of the described interior components can be freely combined with one another, if technically practical, without departing from the scope of the present invention.

### LIST OF REFERENCE SIGNS

1 covering layer
2 support layer
3 haptic layer
4 protective layer
10 interior component for a motor vehicle

1. An interior component for a motor vehicle, wherein the interior component has a covering layer of natural fibre nonwoven materials hardened by fluid jet or a covering layer of a mixture of different natural fibre nonwoven materials hardened by fluid jet, wherein at least on the side facing the interior of the motor vehicle in the installed condition of the interior component a thin protective coating is disposed on the covering layer.

2. The interior component according to claim 1, wherein the covering layer has a natural fibre nonwoven material hardened by water jet or mixture of different natural fibre nonwoven materials hardened by water jet.

3. The interior component according to claim 1, wherein the covering layer has a small proportion of synthetic fibres.

4. The interior component according to claim 1, wherein the natural fibre nonwoven material of the covering layer includes cotton, flax, jute, hemp, kenaf, sisal, abaca, coconut and/or viscose.

5. The interior component according to claim 1, wherein the covering layer is disposed on a support layer of the interior component.

6. The interior component according to claim 5, wherein the support layer is constructed as a plastic part, in particular an injection moulded plastic part, and/or as a natural fibre pressed material.

7. The interior component according to claim 5, wherein a haptic layer, in particular of polyurethane or thermoplastic elastomer, is disposed between the support layer and the covering layer.

8. The interior component according to claim 1, wherein at least in the installed state of the interior component the covering layer has a smooth surface on the side facing the interior of the motor vehicle.

9. The interior component according to claim 1, wherein at least in the installed state of the interior component the covering layer is structured on the side facing the interior of the motor vehicle.

10. The interior component according to claim 1, wherein the covering layer is at least partially perforated and/or embossed.

11. The interior component according to claim 1, wherein the covering layer is made dirt- and moisture-repellent, scratch-resistant, climate-proof and/or radiation-resistant by dipping in a liquid.

12. The interior component according to claim 1, wherein the protective layer is transparent.

13. The interior component according to claim 1, wherein the protective layer is made dirt- and moisture-repellent, scratch-resistant, climate-proof and/or radiation-resistant.

14. The interior component according to claim 1, wherein the interior component is a cockpit component of the motor vehicle, in particular of the instrument panel.

15. A motor vehicle having at least one interior component, wherein the interior component is constructed according to claim 1.

16. Use of a natural fibre nonwoven material hardened by fluid jet, in particular hardened by water jet, or a mixture of natural fibre nonwoven materials hardened by fluid jet, in particular hardened by water jet, as covering layer in an interior component, in particular a cockpit component, of a motor vehicle.

17. Method for producing a covering layer of an interior component for a motor vehicle, wherein the method is characterised by the following method steps:
a) A natural fibre nonwoven material which has a weight per unit area of 100 to 1000 g/m² or a mixture of different natural fibre nonwoven materials which has a weight per unit area of 100 to 1000 g/m² is hardened by fluid jet hardening at a pressure of over 100 bars, and
b) then in a calender embossing of at least a part of the surface of the hardened natural fibre nonwoven material or of the hardened mixture of different natural fibre nonwoven materials is produced.

18. The method according to claim 17, wherein the weight per unit area of the natural fibre nonwoven material or of the mixture of different natural fibre nonwoven materials is 100 to 350 g/m².

19. The method according to claim 17, wherein a protective layer is applied to the surface of the covering layer.

20. The method according to claim 19, wherein the protective layer is applied by arrangement of a thin film, by application of a paint layer or by pouring polyurethane over the covering layer in a shaping tool.

21. The method according to claim 19, wherein the protective layer is made dirt- and moisture-repellent, scratch-resistant, climate-proof and/or radiation-resistant.

22. The method according to claim 17, wherein the fluid jets are applied to the unhardened natural fibre nonwoven material or the unhardened mixture of different natural fibre nonwoven materials at a speed of up to 350 m/s.

23. The method according to claim 17, wherein the hardening of the natural fibre nonwoven material or of the mixture of different natural fibre nonwoven materials is carried out by vapour jets or by liquid jets.

24. The method according to claim 17, wherein the covering layer is disposed on a support layer of the interior component.
